(19) United States
(12) Patent Application Publication
(10) Pub. No.: US 2011/0161175 A1
(43) Pub. Date: Jun. 30, 2011

(54) CUSTOMIZED PROMOTIONS FOR TELEVISION

(75) Inventors: Raul I. ALDREY, Dallas, TX (US); Nicky P. JOSHI, Flower Mound, TX (US)

(73) Assignee: VERIZON PATENT AND LICENSING, INC., Basking Ridge, NJ (US)

(21) Appl. No.: 12/648,840

(22) Filed: Dec. 29, 2009

(51) Int. Cl. G06Q 30/00

(52) U.S. Cl. 705/14.66; 705/14.49

(57) ABSTRACT

A method is performed by one or more devices within a network to provide customized promotions. The method includes retrieving account profile information associated with a media client, where the account profile information includes information, obtained by the media client, about devices within customer premises associated with the media client. The method also includes retrieving a listing of candidate advertising components for a customized promotion and selecting, based on the account profile information, a particular advertising component from the listing of candidate advertising components. Instructions for presenting the selected advertising component are sent to the media client.

### BACKGROUND INFORMATION

Customized promotions and directed advertisements provide potential customers with offers for products and/or services based on information specific to a particular customer or a group of similarly situated customers. Customized promotions generally have proven to generate improved response rates from the targeted audience. Interactive television applications are continuing to be developed to permit consumers to purchase products and/or services via a subscription television network. Providing customized promotions to these consumers may improve revenues generated from such interactive television applications.

### BRIEF DESCRIPTION OF THE DRAWINGS

FIG. 1 depicts an exemplary network in which systems and/or methods described herein may be implemented;

FIG. 2 is a block diagram of exemplary components of a media client that may be used in the network of FIG. 1;

FIG. 3 is a block diagram of exemplary components of a device that may correspond to a backend server of FIG. 1;

FIG. 4 depicts a diagram of exemplary functional components of the backend server illustrated in FIG. 1;

FIG. 5 depicts a diagram of exemplary functional components of the media client illustrated in FIG. 1;

FIG. 6 is a flow chart illustrating an exemplary process for providing customized promotions in a closed distribution network;

FIG. 7 is a flow chart illustrating an exemplary process for generating an account profile according to implementations described herein;

FIG. 8 is a flow chart illustrating another exemplary process for providing customized promotions; and

FIGS. 9A and 9B are exemplary diagrams illustrating implementations of a customer interface for presenting customized promotions in a closed distribution network.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein may permit a subscription multimedia service provider to present customized promotions via a media client/television display based on knowledge of the equipment within the customer's premises, current service levels for the customer, and/or past customer interactions.

The term “promotion,” as used herein, may refer to multimedia item for presentation to a viewer to advertise a product or service. A promotion may include an interactive or non-interactive multimedia item, such as, for example, a banner, an image, a screen overlay, a video segment, an interactive menu, etc. Also, as used herein, the term “media client” may refer to any media processing device that may receive multimedia content over a network, and may provide such multimedia content to an attached display device (such as a television or computer monitor). A “subscription multimedia service,” as used herein, may refer to television, telephone, networking and/or other multimedia services provided to customers over a closed distribution network. A closed distribution network may include, for example, cable, optical fiber, satellite, or virtual private networks that restrict unauthorized alteration of content delivered by a multimedia service provider. Also, as used herein, the terms “user,” “viewer,” “subscriber,” “consumer,” and “customer” may refer interchangeably to a person who interacts with, orders, uploads, listens to, or plays multimedia content from a subscription multimedia service.

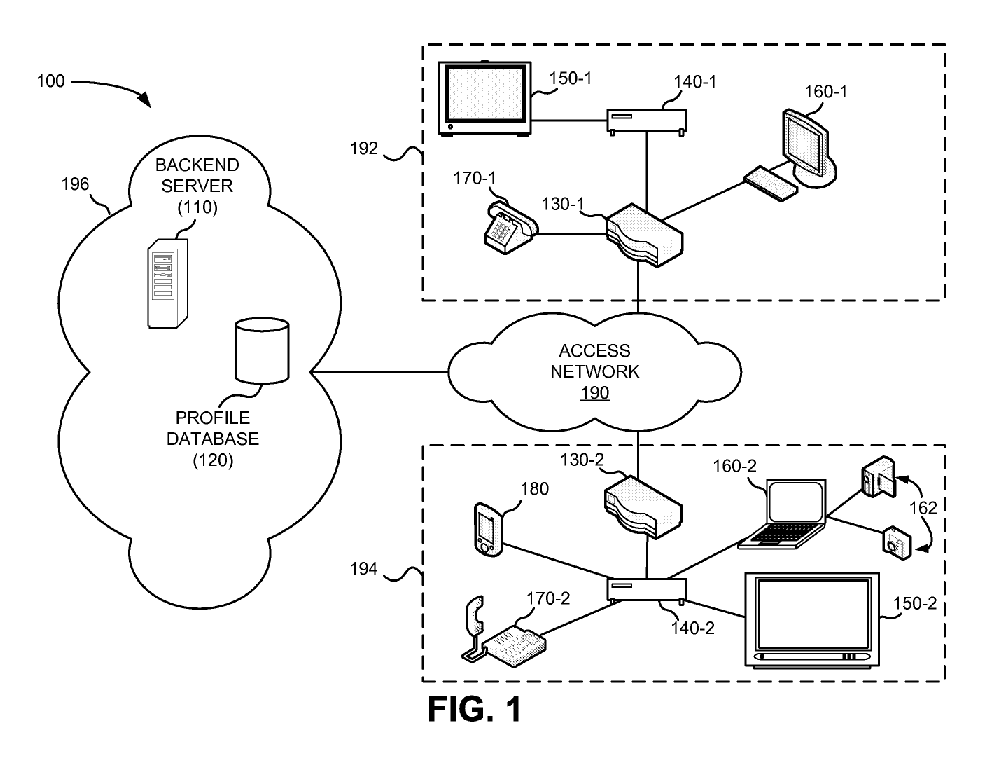

FIG. 1 is a diagram of an exemplary network 100 in which systems and/or methods described herein may be implemented. As illustrated, network 100 may include a backend server 110, a profile database 120, gateways 130-1 and 130-2 (herein referred to collectively as “gateways 130” and generically as “gateway 130”), media clients 140-1 and 140-2 (herein referred to collectively as “media clients 140” and generically as “media client 140”), display devices 150-1 and 150-2 (herein referred to collectively as “display devices 150” and generically as “display device 150”), computing devices 160-1 and 160-2 (herein referred to collectively as “computing devices 160” and generically as “computing device 160”), telephones 170-1 and 170-2 (herein referred to collectively as “telephones 170” and generically as “telephone 170”), cellular phone 180, and an access network 190. Computing devices 160 may be locally networked to one or more peripheral devices 162.

Gateways 130, media clients 140, display devices 150, computing devices 160, telephones 170, and cellular phone 180 may be located on (or associated with) a customer's premises, such as customer premises 192 and 194. Backend server 110, profile database 120 and advertising catalog may be included within a provider network 196. Customer premises 192/194 may connect to provider network 195 via access network 190. Components of network 100 may interconnect via wired and/or wireless connections.

Backend server 110 may include one or more server devices, or other types of computation or communication devices, that are capable of providing content/information to media client 140 and/or display device 150 in accordance with signals that are issued from media client 140. Examples of backend server 110 may include an advertising server that provides advertising associated with multimedia content, a headend device that provides broadcast television programs and/or pay-per-view (PPV) events, a video-on-demand (VOD) device or another device that provides multimedia content upon request, and/or a program guide information server that provides information related to multimedia content available to media client 140. In general, backend server 110 may provide control over (e.g., via access network 190) promotions associated with television services for devices, such as media clients 140, display devices 150, and/or other network connectivity devices (e.g., computing devices 160, telephones 170, cellular phones 180, etc.) provided at customer premises (e.g., customer premises 192/194). Backend server 110 may communicate with a variety of other components, such as databases, gateways, web servers, network switches or routers, television broadcast facilities, and other servers to facilitate delivery of promotions to customers via access network 190.

Database 120 may include one or more memory devices that maintain user account profiles for media clients 140. In one implementation, database 120 may include account information regarding current subscriptions with a multimedia service provider. Subscription information may include services (e.g., television, Internet, landline phone, and/or mobile phone service packages), hardware (e.g., media client models, remote control types, telephone models, mobile phone models, etc.), and software (e.g., media client operating system, etc.) associated with customer premises 192/194. Database 120 may also include customer transaction histories (e.g., responses and/or purchases related to transactional advertisements) provided from media clients 140. Database 120 may further include information regarding other equipment associated with customer premises 192/194 (e.g., equipment not particularly related to current subscriptions with a multimedia service provider). For example, database 120 may store information regarding features of display devices 150 (e.g., high-definition (HD)/standard definition (SD), computing devices 160, telephones 170, etc. While only one database is shown in FIG. 1, database 120 may include multiple databases stored locally at backend server 110 and/or stored at one or more different and possibly remote locations. Database 120 may group account profiles based on individual users or user groups (e.g., based on common transaction histories, same equipment/service types, etc.). Information from database 120 may be retrieved by backend server 110 (or another server device) to generate customized promotions and, for example, to monitor advertising data, such as viewer response rates, revenue, etc.

Gateway 130 may include a network device that provides an interface from access network 190 to media clients 140, computing devices 160, telephones 170, and other network connectivity devices (not shown). For example, when telecommunication services are provided to one of customer premises 192/194 via an optical fiber, gateway 130 may include an optical network terminal (ONT) that connects to the optical fiber. The ONT may convert between signals appropriate for display device 150 and signals appropriate for transmission over optical fiber. For example, the ONT may include a coaxial cable connection that leads to media client 140. The ONT may also include an Ethernet output port that connects to computing device 160, a VoIP telephone and/or a standard telephone port for connecting to a standard telephone.

Gateway 130 may include one of a number of possible gateway devices, including, for example, a satellite antenna and receiver, a coaxial cable connection, an ONT, or a broadband access for Internet Protocol TV (IPTV). The satellite antenna and receiver may provide an interface for multimedia service broadcast from satellites. The coaxial cable connection may provide an interface for multimedia service connected to a customer via coaxial cables. The ONT may provide an interface for an optical fiber connection. The broadband IPTV connection may generally include any device that provides broadband access over which multimedia service may be provided.

Media client 140 may include any device capable of receiving, transmitting and/or processing information to and/or from access network 190. In one implementation, media client 140 may be a closed device (e.g., including a hardware/software configuration that is not accessible to the general public) that restricts unauthorized alteration of programming delivered over a closed distribution network. Media client 140 may provide video signals to display device 150. Examples of media client 140 may include a set-top box, a computer, a cable card, and a portable electronic device. Media client 140 may, for example, receive a television signal from gateway 130, may convert the signal to a form usable by display device 150, and may transmit the signal to display device 150 for display. In some implementations, media client 140 may serve as a hub for multiple devices, such as display device 150-2, computing device 160-2, telephone 170-2, and cellular phone 180-2 of customer premises 194.

In some implementations, media client 140 may also detect features of devices in communication with media client 140, such as display devices 150, computing devices 160, telephones 170, cellular phones 180, etc. Media client 140 may further allow a user to provide user input for interactive television applications (e.g., to navigate menu displays or select menu items) and to alter the programming provided to display device 150 based on a signal (e.g., a channel up or channel down signal) receive from, for example, a remote control. In some implementations (e.g., when authorized by a customer), user input, features of other devices, and other data may be tracked/stored within a memory of media client 140. Media client 140 may also be capable of sending data (e.g., user input records, features of other devices, etc.) to and/or receiving data from backend server 110, computing devices 160, telephones 170, cellular phones 180, etc. In some implementations, media client 140 may be incorporated into display device 150, such as a television, a computer, or a portable electronic device.

Display device 150 may include a digital or analog display via which a user may view multimedia content (including, for example, conventional programming, interactive displays, and/or promotions). Display device 150 may refer to any device that can receive and display multimedia content delivered over access network 190 and/or through media client 140 for perception by users. Display device 150 may include technologies, such as cathode ray tube (CRT) displays, liquid crystal displays (LCDs), light-emitting diode (LED) displays, plasma displays, etc.

Computing device 160 may include a device such as, for example, a desktop computer, laptop computer, personal digital assistant (PDA), etc., used for general computing tasks. In some implementations, computing device 160 may be configured to receive and display television programming (e.g., IPTV). Computing devices 160 may also be used by users to access accounts with Internet service providers (ISPs) to send/receive content over access network 190.

Computing device 160 may be in communication with one or more peripheral devices 162. Peripheral devices 162 may include electronic devices that may be connected to a computing device 160. Peripheral devices 162 may include, for example, digital cameras, video recorders, personal digital assistants (PDAs), portable gaming devices, portable storage devices, or other electronic devices that may be capable of receiving multimedia content.

Telephone 170 may include may include telephones designed to communicate over the public switched telephone network (PSTN) and/or telephones 170 designed to communicate based on the voice over IP (VoIP) protocol.

Cellular phone 180 may include a radiotelephone, a personal communications system (PCS) terminal (e.g., that may combine a cellular radiotelephone with data processing and data communications capabilities), a wireless telephone, a cellular telephone, a smart phone, a PDA (e.g., that can include a radiotelephone, a pager, Internet/intranet access, etc.), a laptop computer (e.g., with a broadband air card), or other types of communication devices. In some implementations, cellular phone may communicate with media client 140 via wired (using, e.g., a USB port) and/or wireless (e.g., Bluetooth) connections.

Access network 190 may include a video signaling and distribution network and system that permit transfer of data between backend server 110 and gateway 130/media clients 140. Additionally, access network 190 may include, among other things, a firewall, a filtering mechanism, a proxy, and/or network address translation mechanisms. Access network 190 may include, for example, a single network, such as a wide area network (WAN), a local area network (LAN), a metropolitan area network (MAN), a telephone network (e.g., a PSTN or a wireless network), the Internet, a satellite network, etc., or a combination of networks. Access network 190 may provide customers, within a closed distribution network, with multimedia content provided, for example, by backend server 110. Access network 190 may also support communications between backend server 110 and media clients 140 using, for example, Internet protocol.

In implementations described herein, backend server 110 may assemble an account profile for each media client 140. The account profile may include, for example, local device data collected by each respective media client 140, usage metrics collected by each respective media client 140, and user account records associated with each media client 140. Media client 140 may send, to backend server 110, a request for customized promotional offer. For example, a dedicated space for a promotional offer may be included within a linear or interactive program segment being presented on display device 150 (e.g., based on a viewer selection of a particular channel/application). Instructions may be provided with the linear or interactive program segment to request a customized promotion from backend server 110. Backend server 110 may receive the request, retrieve the account profile associated with media client 140, and select an appropriate promotion from a catalog of advertisements based on the account profile. Backend server 110 may then send the selected promotion to media client 140 for presentation to the viewer.

The number of components illustrated in FIG. 1 is provided for simplicity. In practice, network 100 could include fewer, different, differently arranged, or additional components than illustrated in FIG. 1. For example, backend server 110 may include a virtual server, that is, the server may include a group of servers that may logically appear as one server. Also, backend server 110 and/or profile database 120 may connect to one or more databases and other servers (not shown) to store and/or retrieve customer data and/or multimedia content. Additionally, each of customer premises 192/194 may include fewer, different, differently arranged, or additional devices than shown in FIG. 1. Furthermore, in some instances, one or more of the components of network 100 may perform one or more functions described as being performed by another one or more of the components of network 100.

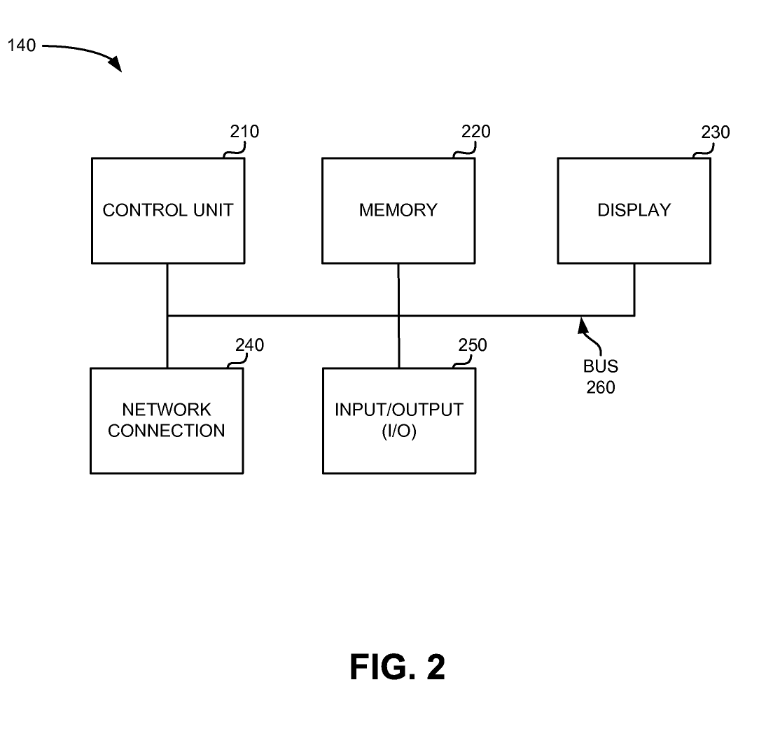

FIG. 2 is diagram illustrating exemplary components of media client 140. As shown, media client 140 may include a control unit 210, a memory 220, a display 230, a network connection 240, an input/output (I/O) component 250, and a bus 260.

Control unit 210 may include one or more processors, microprocessors, or another type of processing device that interprets and executes instructions. Among other functions, control unit 210 may collect/store viewer activity associated with television programming and information about local devices (e.g., devices which may be in communication with media client 140). Control unit 210 may execute instructions to send collected data to another device, such as backend server 110. Control unit 210 may also receive information and/or instructions from other devices, such as backend server 110.

Memory 220 may include one or more dynamic or static storage devices that may store information and instructions for execution by control unit 210. For example, memory 220 may include a storage component, such as a random access memory (RAM), a dynamic random access memory (DRAM), a static random access memory (SRAM), a synchronous dynamic random access memory (SDRAM), a ferroelectric random access memory (FRAM), a read only memory (ROM), a programmable read only memory (PROM), an erasable programmable read only memory (EPROM), an electrically erasable programmable read only memory (EEPROM), and/or a flash memory. In one implementation, memory 220 may store an activity log and a local device log to send at a later point in time, such as when requested by backend server 110.

Display 230 may include any component capable of providing visual information. For example, in one implementation, display 230 may be a light emitting diode (LED) or a liquid crystal display (LCD). In another implementation, display 230 may use another display technology, such as a dot matrix display, etc. Display 230 may display, for example, text (such as a time, a date or a channel selection), image, and/or video information.

Network connection 240 may include any transceiver-like mechanism that enables media client 140 to communicate with other devices and/or systems, such as backend server 110 and computing device 160. For example, network connection 240 may include an Ethernet interface, an optical interface, a coaxial interface, a radio interface, a USB interface, or the like. Network connection 240 may allow for wired and/or wireless communication.

Input/output devices 250 may generally include user input devices such as external buttons, and output devices, such as LED indicators. With input/output devices 250, a user may generally interact with media client 140. In some implementations, input/output devices 250 may be implemented via a remote control. Bus 260 may provide an interface through which components of media client 140 can communicate with one another.

As will be described in detail below, media client 140 may perform certain operations relating to gathering information, receiving information, and communicating information to a server, such as backend server 110. Media client 140 may perform these operations in response to control unit 210 executing software instructions contained in a computer-readable medium, such as memory 220. A computer-readable medium may be defined as a physical or logical memory device. A logical memory device may refer to memory space within a single, physical memory device or spread across multiple, physical memory devices. The software instructions may be read into memory 220 from another computer-readable medium or from another device. The software instructions contained in memory 220 may cause control unit 210 to perform processes that will be described later. Alternatively, hardwired circuitry may be used in place of or in combination with software instructions to implement processes described herein. Thus, implementations described herein are not limited to any specific combination of hardware circuitry and software.

Although FIG. 2 illustrates exemplary components of media client 140, in other implementations, media client 140 may include fewer, different, differently arranged, or additional components than those depicted in FIG. 2. Additionally, or alternatively, one or more components of media client 140 may perform one or more other tasks described as being performed by one or more other components of media client 140.

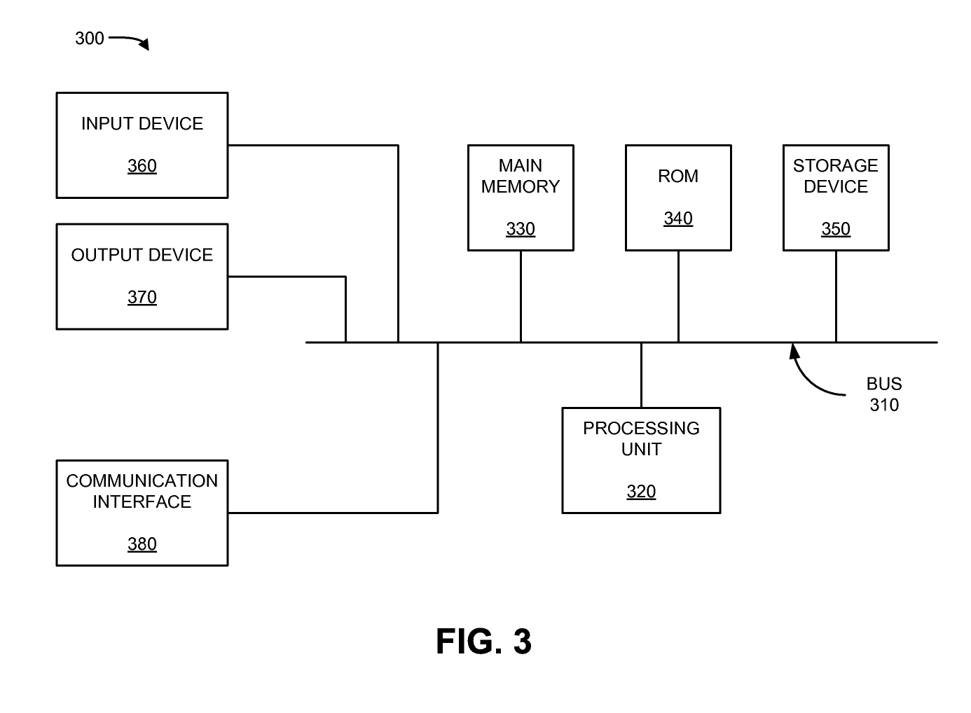

FIG. 3 is a diagram of exemplary components of a device 300 that may correspond to backend server 110 and/or another device such at computing device 160. As illustrated, device 300 may include a bus 310, a processing unit 320, a main memory 330, a read-only memory (ROM) 340, a storage device 350, an input device 360, an output device 370, and a communication interface 380.

Bus 310 may include a path that permits communication among the components of device 300. Processing unit 320 may include one or more processors, microprocessors, or other types of processing units, such as application-specific integrated circuits (ASICs), field-programmable gate arrays (FPGAs), etc., that may interpret and execute instructions.

Main memory 330 may include a RAM or another type of dynamic storage device that stores information and instructions for execution by processing unit 320. ROM 340 may include a ROM device or another type of static storage device that may store static information and instructions for use by processing unit 320. Storage device 350 may include a magnetic and/or optical recording medium and its corresponding drive. In one implementation, storage device may include a database (e.g., profile database 120).

Input device 360 may include a mechanism that permits an operator to input information to device 300, such as a keyboard, a mouse, a pen, voice recognition and/or biometric mechanisms, a touch-screen interface, etc. Output device 370 may include a mechanism that outputs information to the operator, including a display, a printer, a speaker, etc. Communication interface 380 may include any transceiver-like mechanism that enables device 300 to communicate with other devices and/or systems, such as media client 140.

As will be described in detail below, device 300 may perform certain operations associated with providing customized promotions for a subscription multimedia service. Device 300 may perform these and other operations in response to processing unit 320 executing software instructions contained in a computer-readable medium, such as main memory 330. The software instructions may be read into main memory 330 from another computer-readable medium, such as storage device 350, or from another device via communication interface 380. The software instructions contained in main memory 330 may cause processing unit 320 to perform processes that will be described later. Alternatively, hardwired circuitry may be used in place of, or in combination with, software instructions to implement processes consistent with exemplary implementations. Thus, implementations described herein are not limited to any specific combination of hardware circuitry and software.

Although FIG. 3 illustrates exemplary components of device 300, in other implementations, device 300 may include fewer, different, differently arranged, or additional components than those depicted in FIG. 3. Additionally, or alternatively, one or more components of device 300 may perform one or more other tasks described as being performed by one or more other components of device 300.

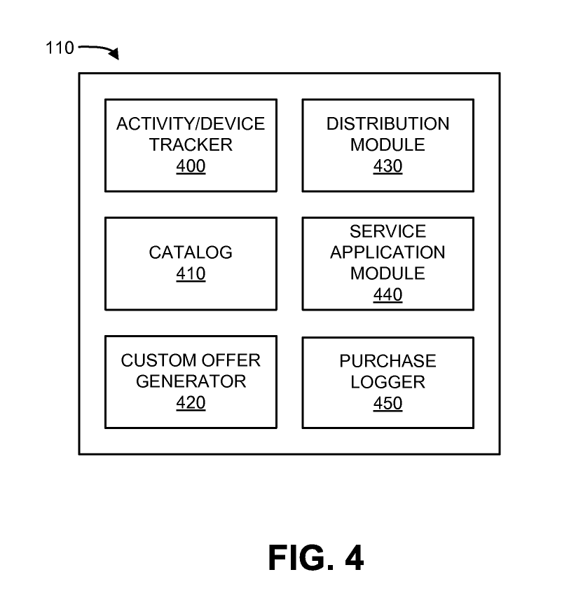

FIG. 4 is an exemplary diagram of functional components of backend server 110. The functional components of backend server 110 may be implemented by, for example, one or more of the components of device 300 (FIG. 3). As shown, backend server 110 may include an activity/device tracker 400, an advertising catalog 410, a custom offer generator 420, a distribution module 430, a service application module 440, and/or a purchase logger 450.

Activity/device tracker 400 may include hardware or a combination of hardware and software to receive and/or solicit user activity data and local device data from media clients 140. For example, activity/device tracker 400 may receive customer transaction histories (e.g., user responses and/or purchases related to transactional advertisements) and information regarding other equipment associated with customer premises 192/194 (e.g., equipment not particularly related to current subscriptions with a multimedia service provider) provided from media clients 140. In some implementations, activity/device tracker 400 may receive updated information from media clients 140 at regular intervals or upon particular activities (e.g., upon a startup sequence). In other implementations, activity/device tracker 400 may send a signal to a media client 140 to request updated information as needed. In still other implementations, updated activity and/or device information may be provided to activity/device tracker 400 in association with a request, from media client 140, for a customized promotion.

Additionally, or alternatively, activity/device tracker 400 may receive subscription records associated with particular media clients 140. For example, subscription records may include particular services and/or equipment which a customer (e.g., a customer associated with one or more particular media clients 140) has purchased and indications of when particular service contracts may be expiring (if applicable). Subscription records may be provided, for example, by another device within provider network 196. Data received by activity/device tracker 400 may be associated with an account profile and stored in a memory, such as profile database 120.

Advertising catalog 410 may include hardware or a combination of hardware and software that maintains available advertising components that may be candidates for customized promotions. Advertising catalog may receive updated advertising components, for example, from another device controlled by a network administrator. In one implementation, advertising components may include, for example, offers for particular services, equipment, and/or software. For example, a multimedia service provider may offer multiple promotions for particular bundles of services and/or equipment (such as television, Internet, and/or telephone packages). As another example, advertising components may include offers for particular upgrades, accessories, and/or services (such as software, equipment, and/or content that may be well suited to enhance or make use of existing services). In one implementation, advertising components may include data that may be inserted, by media client 140, into a template for presentation on display device 150. In other implementations, advertising components may include discrete program segments or files.

Custom offer generator 420 may include hardware or a combination of hardware and software to determine a customized promotion for presentation by a particular media client 140. For example, custom offer generator 420 may receive a request to generate a customized promotion for a particular media client 140. The request may be generated internally from backend device 110 or from another device within provider network 196 or the request may be generated by a media client 140. The request may be provided in advance of presentation to a viewer (e.g., to provide information to media clients 140 that may be stored locally by media clients 140 for later presentation) or provided in real-time (e.g., in conjunction with a trigger to generate a customized promotion for presentation to a viewer). In response to the request, custom offer generator may retrieve (e.g., from profile database 120) account profile information for the particular media client 140.

Custom offer generator 420 may retrieve a listing of advertising components from advertising catalog 410 and compare information in the account profile with available advertising components from advertising catalog 410 to identify an appropriate promotion for the particular media client 140. In one implementation, custom offer generator 420 may apply an algorithm to identify which advertising components may be relevant to a particular customer/media client 140 and then to determine, among the relevant advertising components, which particular advertising component to provide to the particular media client 140. An advertising component may be deemed relevant, for example, based on whether (or not) the account profile indicates a consumer already has particular products/services and/or has equipment to support certain services. As an example, where the account profile associated with the particular media client 140 includes an indication that the media client 140 is connected to an HD display and the current service subscription does not include certain HD channels, custom offer generator 420 may identify an advertising component from a group of advertising components that promotes HD multimedia services. Conversely, if the account profile associated with the particular media client 140 includes an indication that the media client 140 is not connected to an HD display, custom offer generator 420 may exclude certain HD-related offerings from the group of relevant advertising components for that particular media client 140.

Custom offer generator 420 may select from advertising components including a variety of products and services, such as video content, wireless service plans, accessories, peripherals, consumer electronics, and combinations thereof. Thus, implementations described herein are not limited to any particular range of products or services, in one implementation, selected advertising components may include promotions for device upgrades that may be required to present services of a multimedia service provider. For example, an advertising component may promote an upgraded device (e.g., upgrading over an existing device listed in a user's account profile information), in combination with a service that uses the upgraded device.

Distribution module 430 may include hardware or a combination of hardware and software to send selected advertising components to media client 140. For example, distribution module 430 may send selected advertising components in-band within other multimedia content, such as video, audio, interactive applications, and/or images that may be requested by media client 140. Additionally, or alternatively, distribution module 430 may send selected advertising components using an out-of-band distribution method.

Service application module 440 may include hardware or a combination of hardware and software to provide and/or update media client 140 applications to facilitate customized promotions. Such applications to facilitate customized promotions may include applications to enable interactive advertising and instructions for media client 140 to collect/provide updated activity and/or device information to backend server 110.

Purchase logger 450 may include hardware or a combination of hardware and software to collect user activity logs from media client 140 and to parse the activity logs for information relevant to promotions. In one implementation, purchase logger 450 may receive information directly from media clients 140. In other implementations, purchase logger 450 may receive media client 140 information indirectly from another backend device (e.g., a data processing server).

Although FIG. 4 illustrates exemplary functional components of backend server 110, in other implementations, backend server 110 may include fewer, different, differently arranged, or additional functional components than those depicted in FIG. 4. Additionally, or alternatively, one or more functional components of backend server 110 may perform one or more other tasks described as being performed by one or more other functional components of backend server 110.

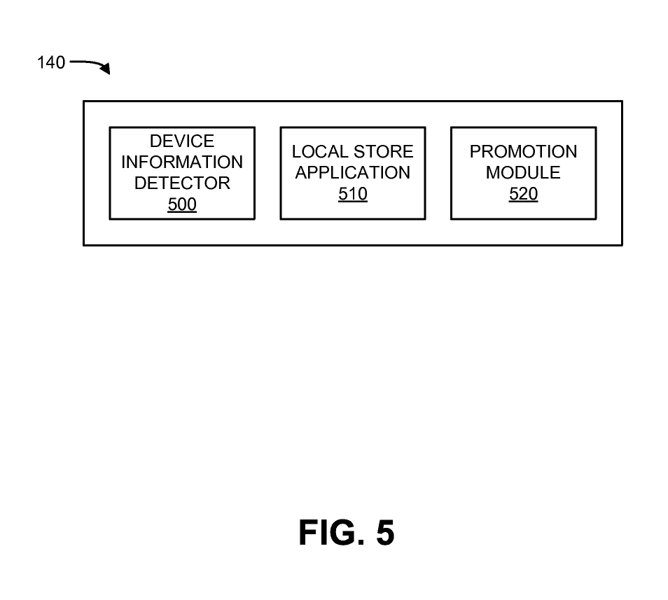

FIG. 5 is a diagram of exemplary functional components of media client 140. The functional components of media client 140 may be implemented by, for example, one or more of the components of FIG. 2. As shown, media client 140 may include a device information detector 500, a local store application 510, and promotion module 520.

Device information detector 500 may include hardware or a combination of hardware and software to collect and/or solicit user activity data and local device data at customer premises 192/194. For example, device information detector 500 may track user interactions with media client 140. User interactions may include, for example, commands issued from a viewer via a remote control, such as channels selected, services ordered, searches performed, etc. In one implementation, device information detector 500 may include user controls to restrict tracking of some or all user interactions with media client 140.

Device information detector 500 may also obtain information about devices associated with customer premises 192/194, such as display devices 150, computing devices 160, peripheral devices 162, telephones 170, and/or cellular phones 180. In one implementation, device information detector 500 may obtain device information based on connections (e.g., wired or wireless connections) with other devices. In one example, the type of physical connection between media client 140 and display device 150 may be indicative of whether display device is a SD- or HD-capable display. As another example, device information detector 500 may use a wireless connection with a remote control to determine whether the remote control is, for example, an original equipment manufacturer (OEM) item or an after-market accessory. In another implementation, device information detector 500 may send a request to a connected device (e.g., computing device 160, cellular phone 180, etc.) to identify hardware and/or peripheral devices (e.g., peripheral devices 162) that may utilize services/products from the multimedia service provider. In still another implementation, device information detector 500 may solicit information about attached devices from a viewer (e.g., via providing interactive menu options) when, for example, a connection to an auxiliary port of media client 140 is detected. For example, when a user connects a digital video recorder (DVR) to media client 140, media client 140 may solicit information from the user when the device is initially detected.

Device information detector 500 may store user interaction histories and information regarding other equipment associated with customer premises 192/194 in a local memory (e.g., memory 220) to send to backend server 110 at particular intervals, when a customized promotion is being requested, or when requested from backend server 110. Alternatively, or additionally, device information detector 500 may provide real-time updates of user interaction information and/or device information.

Local store application 510 may include hardware or a combination of hardware and software that enables interactive transactions to facilitate purchases via media client 140. A purchase may include a transaction involving an exchange of payment or a transaction to add a selected item to a user account for later payment. For example, when a user responds to a customized promotional offer (e.g., by pressing a particular key on a remote control), local store application 510 may generate a transaction page (e.g., an IP-based interface) that allows the user to complete a transaction for the promoted product/service.

Promotion module 520 may include hardware or a combination of hardware and software to manage insertion of customized promotions. For example, promotion module 520 may identify where/when customized promotions are required within a multimedia presentation and request or retrieve information to supply the customized promotion. In one implementation, promotion module 520 may identify triggers within a multimedia stream to provide a customized promotion. In another implementation, instructions to provide a customized promotion may be provided from backend server 110 using, for example, out-of-band instructions. When a customized promotion (e.g., a particular advertising component) is received from backend server 110, promotion module 520 may insert the customized promotion within the multimedia presentation being viewed by the viewer.

Although FIG. 5 illustrates exemplary functional components of media client 140, in other implementations, media client 140 may include fewer, different, differently arranged, or additional functional components than those depicted in FIG. 5. Additionally, or alternatively, one or more functional components of media client 140 may perform one or more other tasks described as being performed by one or more other functional components of media client 140.

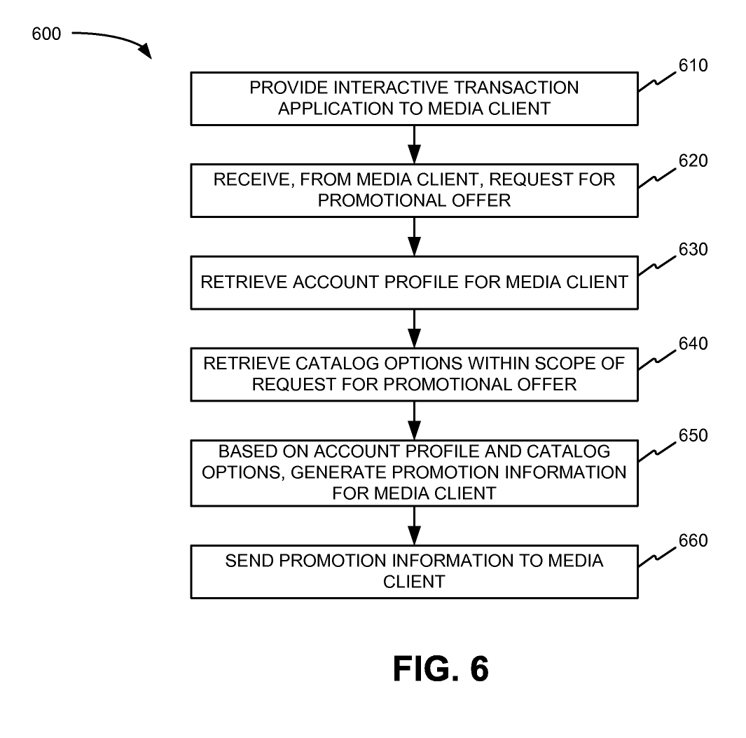

FIG. 6 provides a flow chart of an exemplary process 600 for providing customized promotions in a closed distribution network. Some or all of process 600 may be performed by one or more servers associated with a subscription multimedia service, such as backend server 110. In some implementations, some or all of process 600 may also be performed by one or more media clients 140 in association with backend server 110.

Process 600 may include providing an interactive transaction application to a media client (block 610). For example, as described above in connection with FIG. 4, backend server 110 (e.g., service application module 440) may provide and/or update applications for media client 140 to facilitate customized promotions. Such applications to facilitate customized promotions may include applications to enable interactive advertising and instructions for media client 140 to collect/provide updated activity and/or device information to backend server 110.

A request for a promotional offer may be received from the media client (block 620), and an account profile for the media client may be retrieved (block 630). For example, as described above in connection with FIG. 4, backend server 110 (e.g., custom offer generator 420) may receive a request to generate a customized promotion for a particular media client 140. The request may be generated internally from backend device 110 or from another device within provider network 196 or the request may be generated by a media client 140. The request may be provided in advance of presentation to a viewer (e.g., to provide information to media clients 140 that may be stored locally by media clients 140 for later presentation) or provided in real-time (e.g., in conjunction with a trigger to generate a customized promotion for presentation to a viewer). In response to the request, custom offer generator 420 may retrieve (e.g., from profile database 120) account profile information for the particular media client 140.

Catalog options within the scope of the request of the promotional offer may be retrieved (block 640); based on the account profile and catalog options, promotion information for the media client may be generated (block 650); and the promotion information may be sent to the media client (block 660). For example, as described above in connection with FIG. 4, backend server 110 (e.g., custom offer generator 420) may retrieve a listing of advertising components from advertising catalog 410 and compare information in the account profile with available advertising components from advertising catalog 410 to identify an appropriate promotion for the particular media client 140. In one implementation, custom offer generator 420 may apply an algorithm to identify which advertising components may be relevant to a particular customer/media client 140 and then to determine, among the relevant advertising components, which particular advertising component to provide to the particular media client 140. Distribution module 430 may send selected advertising components in-band within other multimedia content, such as video, audio, interactive applications, and/or images, that may be requested by media client 140. Additionally, or alternatively, distribution module 430 may send selected advertising components using an out-of-band distribution method.

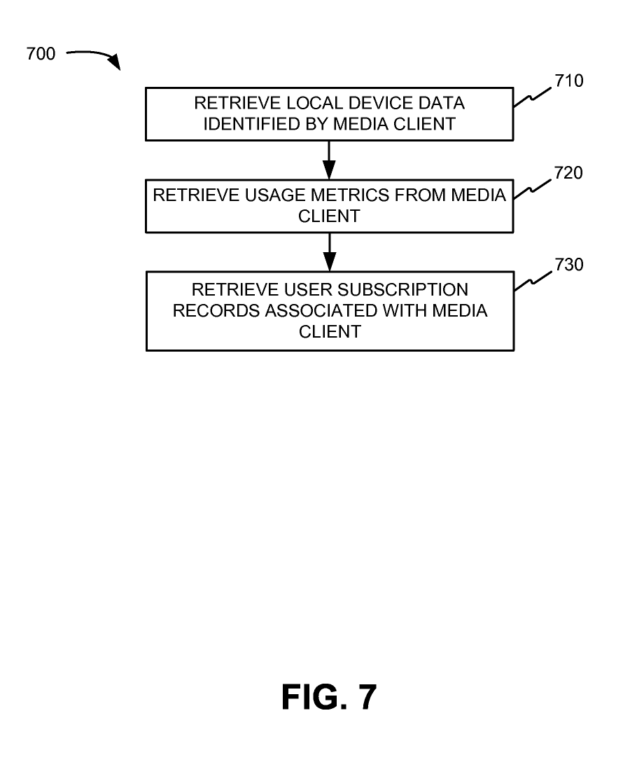

FIG. 7 provides a flow chart of an exemplary process 700 for generating an account profile according to implementations described herein. Some or all of process 700 may be performed by one or more servers associated with a subscription multimedia service, such as backend server 110. In some implementations, some or all of process 700 may also be performed by one or more media clients 140 in association with backend server 110.

Process 700 may include retrieving local device data identified by a media client (block 710) and retrieving usage metrics from the media client (block 720). For example, as described above in connection with FIG. 4, backend server 110 (e.g., activity/device tracker 400) may receive and/or solicit user activity data and local device data from media clients 140. For example, activity/device tracker 400 may receive customer transaction histories (e.g., user responses and/or purchases related to transactional advertisements) and information regarding other equipment associated with customer premises 192/194 (e.g., equipment not particularly related to current subscriptions with a multimedia service provider) provided from media clients 140. In some implementations, activity/device tracker 400 may receive updated information from media clients 140 at regular intervals or upon particular activities (e.g., upon a startup sequence). In other implementations, activity/device tracker 400 may send a signal to a media client 140 to request updated information as needed. In still other implementations, updated activity and/or device information may be provided to activity/device tracker 400 in association with a request, from media client 140, for a customized promotion.

User subscription records associated with the media client may be retrieved (block 730). For example, as described above in connection with FIG. 4, activity/device tracker 400 may receive subscription records associated with particular media clients 140. For example, subscription records may include particular services and/or equipment which a customer (e.g., a customer associated with one or more particular media clients 140) has purchased. Subscription records may be provided, for example, by another device within provider network 196. Data received by activity/device tracker 400 may be associated with an account profile and stored in a memory, such as profile database 120.

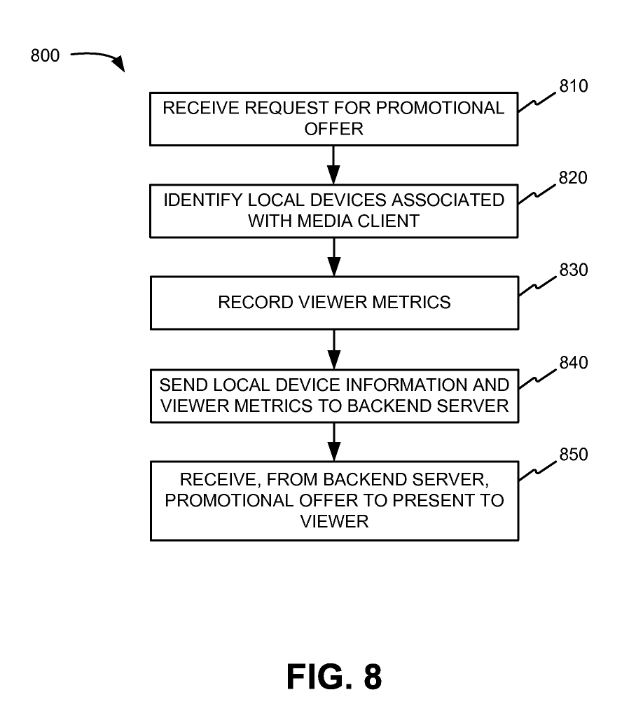

FIG. 8 provides a flow chart of an exemplary process 800 for providing customized promotions. Some or all of process 800 may be performed by a media client associated with a subscription multimedia service, such as media client 140. In some implementations, some or all of process 800 may be performed by media client 140 in conjunction with backend server 110.

Process 800 may include receiving a request for a promotional offer (block 810). For example, as described above in connection with FIG. 5, media client 140 (e.g., promotion module 520) may identify where/when customized promotions are required within a multimedia presentation and request or retrieve information to supply the customized promotion. In one implementation, promotion module 520 may identify triggers within a multimedia stream to provide a customized promotion. In another implementation, instructions to provide a customized promotion may be provided from backend serve 110 using, for example, out-of-band instructions.

Local devices associated with the media client may be identified (block 820) and viewer metrics may be recorded (block 830). For example, as described above in connection with FIG. 5, media client 140 (e.g., device information detector 500) may collect and/or solicit user activity data and local device data at customer premises 192/194. For example, device information detector 500 may track user interactions with media client 140. Device information detector 500 may also obtain information about devices associated with customer premises 192/194. In one implementation, device information detector 500 may obtain device information based on connections with other devices.

Local device information and view metrics may be sent to a backend server (block 840). For example, as described above in connection with FIG. 5, media client 140 (e.g., device information detector 500) may store user interaction histories and information regarding other equipment associated with customer premises 192/194 in a local memory (e.g., memory 220) to send to backend server 110 at particular intervals, when a customized promotion is being requested, or when requested from backend server 110. Alternatively, or additionally, device information detector 500 may provide real-time updates of user interaction information and/or device information.

A promotional offer to present to a viewer may be received from the backend server (block 850). For example, as described above in connection with FIG. 5, when a customized promotion (e.g., a particular advertising component) is received from backend server 110, promotion module 520 may insert the customized promotion within the multimedia presentation being viewed by the viewer.

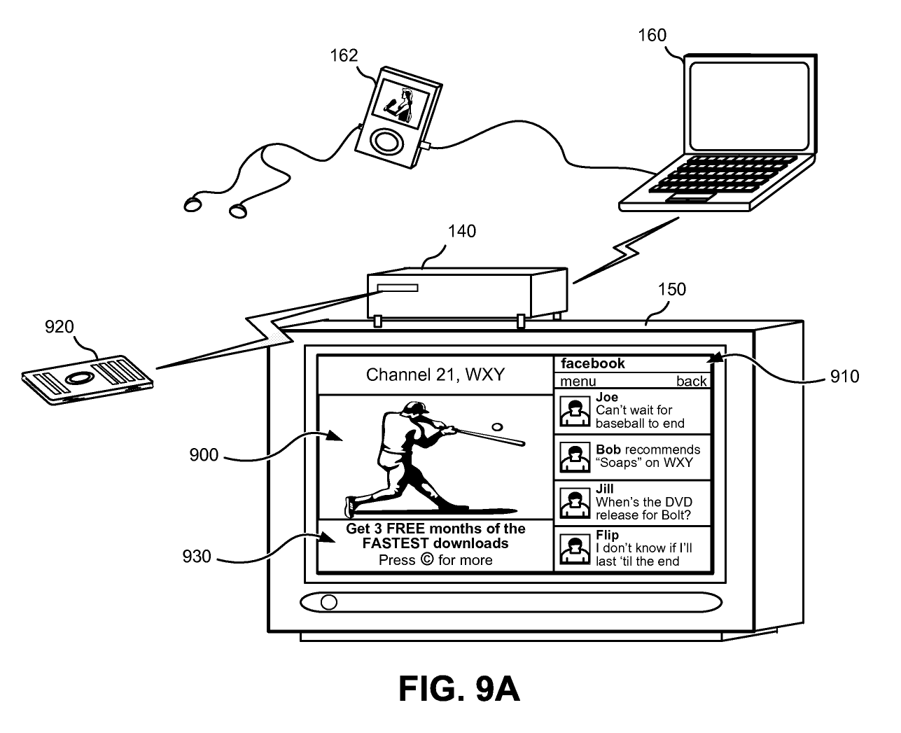

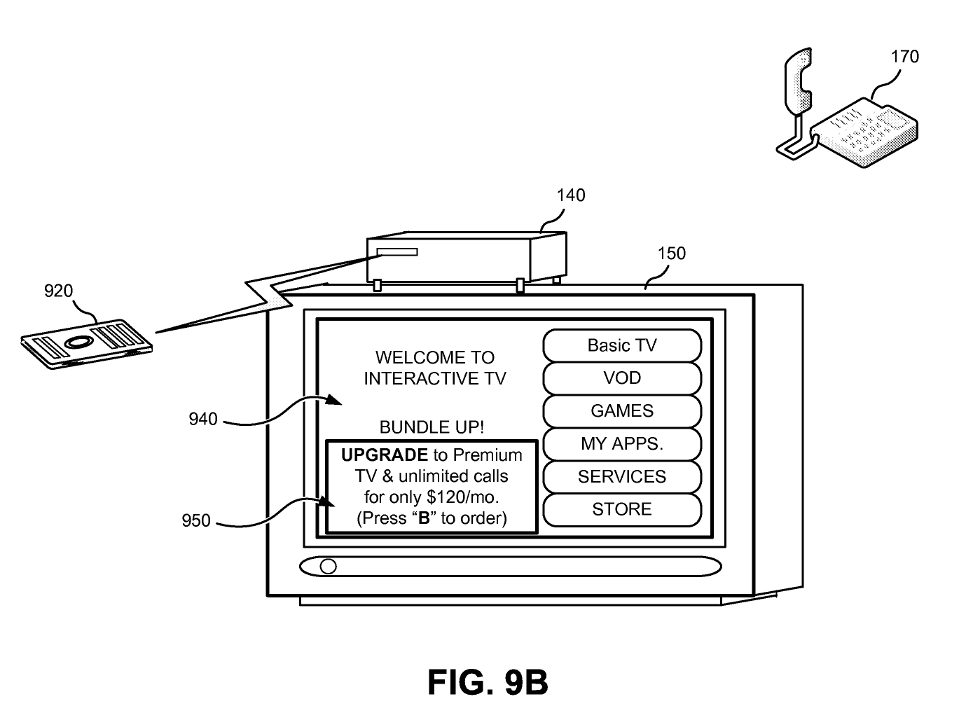

FIGS. 9A and 9B provide exemplary diagrams illustrating implementations of a customer interface for presenting customized promotions. More specifically, FIG. 9A provides an exemplary diagram of an on-screen display that includes a notification of a customized promotion within an interactive television application, and FIG. 9B provides an exemplary diagram of a customized promotion within a start-up menu.

Referring to FIG. 9A, a viewer may view a display on display device 150 that includes a linear program segment 900 and an interactive television application 910. The display on display device 150 may be controlled by media client 140 as directed by user commands from a remote control 920. Remote control 920 may include a range of devices including function specific keys, number keys, and/or a full-text key pad. A user may interact with media client 140 using a keypad that is part of remote control 920, and signals representing key depressions may be transmitted to media client 140 via an infrared transmission or another type of transmission. Remote control 920 may allow a user to navigate a program guide, select channels or programs for viewing, adjust display characteristics, and/or perform other interactive functions related to viewing multimedia content.

In the example of FIG. 9A, interactive television application 910 may include a trigger for a customized promotion to be displayed in a portion 930 of display device 150. Based on the trigger, and prior to presentation of the promotion, media client 140 may provide a request to a backend server (e.g., backend server 110) for information regarding a customized promotion to associate with interactive television application 910. The backend server may use information from the request and account profile information for media client 140 to identify a particular advertising component present in portion 930. Assume in the example of FIG. 9A, the account profile information indicates media client 140 is (or has been) operatively connected to a computing device 160 with a particular peripheral device (e.g., a personal music player). The backend server may determine that an appropriate advertising component may include a promotion for a faster Internet connection. The backend server may send instructions to media client 140 to present the selected adverting component within portion 930. Using remote control 920, the user may select the advertising component to initiate a purchase process for the advertised product or view additional information.

In the example of FIG. 9B, a startup screen 940 may include a trigger for a customized promotion to be displayed in a portion 950 of display device 150. Similar to the process of FIG. 9A, media client 140 may provide a request to the backend server for information regarding a customized promotion to associate with interactive television application startup screen 940. Assume in the example of FIG. 9B, the account profile information indicates the customer associated with media client 140 has basic phone service (e.g., for telephone 170) and basic TV service from the same service provider. The backend server may determine that an appropriate advertising component may include a promotion for a bundled TV/phone service with premium features. The backend server may send instructions to media client 140 to the present the adverting component within portion 950. Using remote control 920, the user may select the advertising component to initiate a purchase process for the advertised services or view additional information.

The illustrations of FIGS. 9A and 9B are exemplary formats for presenting customized promotions in a network. Other formats and variations may be used.

Implementations described herein may provide systems and/or methods that to provide customized promotions within a network. The systems and/or methods may include retrieving account profile information associated with a media client, where the account profile information includes information, obtained by the media client, about devices within customer premises associated with the media client. The systems and/or methods may also include retrieving a listing of candidate advertising components for a customized promotion and selecting, based on the account profile information, a particular advertising component from the listing of candidate advertising components. Instructions for presenting the selected advertising component may be sent to the media client for displaying to a viewer.

The foregoing description provides illustration and description, but is not intended to be exhaustive or to limit the implementations to the precise form disclosed. Modifications and variations are possible in light of the above teachings or may be acquired from practice of systems and/or methods disclosed herein.

For example, while series of blocks have been described with regard to the flowcharts of FIGS. 6-8, the order of the blocks may differ in other implementations. Further, non-dependent blocks may be performed in parallel.

It will be apparent that exemplary aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code--it being understood that software and control hardware could be designed to implement the aspects based on the description herein.

Even though particular combinations of features are recited in the claims and/or disclosed in the specification, these combinations are not intended to limit the invention. In fact, many of these features may be combined in ways not specifically recited in the claims and/or disclosed in the specification.

No element, block, or instruction used in the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A method performed by one or more devices within a closed distribution network, the method comprising:
retrieving, by one of the one or more devices, account profile information associated with a media client, where the account profile information includes information, obtained by the media client, about devices within a customer premises associated with the media client;
retrieving, by one of the one or more devices, a listing of candidate advertising components for a customized promotion;
selecting, by one of the one or more devices and based on the account profile information, a particular advertising component from the listing of candidate advertising components; and
sending, by one of the one or more devices and to the media client, instructions for presenting the selected advertising component.

2. The method of claim 1, further comprising:
providing, by one of the one or more devices and to the media client, instructions for obtaining the information about devices within the customer premises associated with the media client.

3. The method of claim 1, further comprising:
sending, by one of the one or more devices and to the media client, multimedia content, where the multimedia content includes a trigger to initiate presentation of a customized promotion.

4. The method of claim 1, further comprising:
receiving, by one of the one or more devices, a request to provide the customized promotion to the media client.

5. The method of claim 1, where the account profile information further includes one or more of:
current subscriptions, with a multimedia service provider, for a customer associated with the media client,
customer transaction histories, for transactions with the multimedia service provider, associated with the media client, or
customer viewing metrics associated with the media client.

6. The method of claim 5, where the information about the devices within the customer premises associated with the media client includes one or more of:
information based on connections between the media client and other devices,
information based on a response to a request sent by the media client to a connected device, or
user input in response to prompts from the media client about use of auxiliary ports.

7. The method of claim 6, where the request sent by the media client seeks to identify hardware or peripheral devices that utilize services from a multimedia service provider.

8. The method of claim 1, where the selected advertising component includes a promotion for a device that is an upgrade of an existing device in the account profile information.

9. A device, comprising:
a memory to store instructions; and
a processor to execute the instructions to:
send, to a media client, multimedia content, where the multimedia content includes a trigger to initiate presentation of a customized promotion;
retrieve account profile information associated with the media client, where the account profile information includes information, obtained by the media client, about devices within customer premises associated with the media client;
select, from a listing of candidate advertising components for a customized promotion and based on the account profile information, a particular advertising component from the listing of candidate advertising components; and
send, to the media client, instructions for presenting the selected advertising component.

10. The device of claim 9, where the processor is further to execute instructions to:
send, to the media client, instructions for obtaining the information about devices within the customer premises associated with the media client.

11. The device of claim 9, where the processor is further to execute instructions to:
receive, by one of the one or more devices, a request to provide the customized promotion to the media client.

12. The device of claim 9, where the listing of candidate advertising components comprises at least one of:
a banner,
an image,
a screen overlay,
a video segment, or
an interactive menu.

13. The device of claim 9, where the information about the devices within the customer premises associated with the media client includes one or more of:
information based on connections between the media client and other devices,
information based on a response to a request sent by the media client to a connected device, or
user input in response to prompts from media client about use of auxiliary ports.

14. The device of claim 9, where the account profile information further includes one or more of:
current subscription information for a customer associated with the media client,
customer transaction histories, for transactions with a multimedia service provider, associated with the media client, or
customer viewing metrics associated with the media client.

15. The device of claim 9, where the information about the devices within the customer premises associated with the media client includes:
information about devices not supplied by a multimedia service provider associated with the media client.

16. The device of claim 9, where the selected advertising component includes a promotion for a new device, that is an upgrade of an existing device listed in the account profile information, in combination with a service that uses the new device.

17. A method implemented by a media client, the method comprising:
receiving, by the media client, a request for a promotional offer;
identifying, within customer premises associated with the media client, device information for devices associated with the media client;
sending, by the media client and to a server, the device information;
sending, by the media client and to the server, a request for instructions for presenting an advertising component for the promotional offer; and
receiving, by the media client and over a network, the instructions for presenting the advertising component for the promotional offer.

18. The method of claim 17, further comprising:
recording viewer metrics associated with the media client; and
sending, by the media client and to the server, the viewer metrics.

19. The method of claim 17, further comprising:
receiving, by the media client and from a user, a response to the promotional offer; and
presenting, in response to the receiving, an interactive transaction screen that allows the user to complete a transaction for the promotional offer.

20. The method of claim 17, where the information about the devices within the customer premises associated with the media client includes one or more of:
information based on connections between the media client and other devices,
information based on a response to a request sent by the media client to a connected device, or
user input in response to prompts from media client about use of auxiliary ports.

21. The method of claim 17, where the information about the devices within the customer premises associated with the media client includes:
information about devices not supplied by a multimedia service provider associated with the media client.

22. A system, comprising:
one or more devices within a closed distribution network, the one or more devices comprising:
means for identifying, within a customer premises associated with a media client, device information for devices associated with the media client;
means for including the device information within a profile associated with the media client;
means for receiving a request for a customized promotion;
means for retrieving the profile associated with a media client;
means for retrieving a listing of candidate advertising components for the customized promotion;
means for selecting, based on the profile, a particular advertising component from the listing of candidate advertising components; and
means for presenting the advertising component for the promotional offer.

23. The system of claim 22, where the means for identifying device information includes:
means for identifying information about devices not supplied by a multimedia service provider associated with the media client.

24. The system of claim 22, where the device information includes information about devices other than the media client.

25. The system of claim 22, where the profile associated with the media client includes:
current subscription information for a customer associated with the media client,
customer transaction histories, for transactions with a multimedia service provider, associated with the media client, or
customer viewing metrics associated with the media client.
